(19) United States
(12) Patent Application Publication
(10) Pub. No.: US 2024/0220400 A1
(43) Pub. Date: Jul. 4, 2024

(54) CONTROL TEST METHOD AND APPARATUS, COMPUTER DEVICE, AND STORAGE MEDIUM

(71) Applicant: BEIJING YOUZHUJU NETWORK TECHNOLOGY CO., LTD., Beijing (CN)

(72) Inventors: Shujun DENG, Beijing (CN); Guanrui HE, Beijing (CN); Wei SHAO, Beijing (CN); Jinyuan HUANG, Beijing (CN)

(21) Appl. No.: 18/339,517

(22) Filed: Jun. 22, 2023

(30) Foreign Application Priority Data
Dec. 29, 2022 (CN) 202211712316.4

(51) Int. Cl. G06F 11/36

(52) U.S. Cl. CPC G06F 11/3684; G06F 11/3692

(57) ABSTRACT

A control test method includes: obtaining an experimental scheme, and performing quantization processing on experimental variables in the experimental scheme to obtain a quantization index corresponding to each of the experimental variables, in which the experimental variables include a causal variable and an outcome variable; determining an evaluation index corresponding to the quantization index of the outcome variable, and determining, based on the evaluation index, a sample size corresponding to experimental samples in the experimental scheme; and obtaining the experimental samples under the sample size, and dividing the experimental samples into the experimental group and the control group based on a control grouping condition of the experimental scheme, in which the quantization index of the causal variable corresponding to the experimental group is different from the quantization index of the causal variable corresponding to the control group.

### CROSS-REFERENCE TO RELATED APPLICATIONS

The present disclosure relates to the technical field of computer science, and more specifically, to a control test method, a control test apparatus, a computer device, and a storage medium.

### BACKGROUND

A control test method is a method for determining an influence of a single variable on an experimental outcome by means of an experimental group and a control group, which are generated by controlling a change of the variable. The difference of the experimental outcomes with the change of the variable can be determined by using such a method. In order to ensure accuracy of the result obtained by the control test method, a large number of samples may be selected for testing to find a general law, which will easily cause a waste of the experimental samples.

### SUMMARY

Embodiments of the present disclosure at least provide a control test method, a control test apparatus, a computer device, and a storage medium.

In a first aspect, the embodiments of the present disclosure provide a control test method. The control test method includes: obtaining an experimental scheme, and performing quantization processing on experimental variables in the experimental scheme to obtain a quantization index corresponding to each of the experimental variables, wherein the experimental variables include a causal variable and an outcome variable; determining an evaluation index corresponding to the quantization index of the outcome variable, and determining, based on the evaluation index, a sample size corresponding to experimental samples in the experimental scheme, the evaluation index being used for evaluating a difference value between two outcome variables obtained respectively for an experimental group and a control group in the experimental scheme under different causal variables; and obtaining the experimental samples under the sample size, and dividing the experimental samples into the experimental group and the control group based on a control grouping condition of the experimental scheme, for completing the experimental scheme by using the experimental group and the control group, wherein the quantization index of the causal variable corresponding to the experimental group is different from the quantization index of the causal variable corresponding to the control group.

In an optional implementation, said determining, based on the evaluation index, the sample size corresponding to the experimental samples in the experimental scheme includes: determining, by using an independent-samples test method, the sample size corresponding to the experimental samples under the evaluation index; or determining, by using a paired-samples test method, the sample size corresponding to the experimental samples under the evaluation index.

In an optional implementation, the method further includes, prior to said determining, based on the evaluation index, the sample size corresponding to the experimental samples in the experimental scheme: determining a testing error under the experimental scheme and a standard deviation of the experimental samples, wherein the testing error includes a probability of true-rejecting error and a probability of false-accepting error in the experimental scheme, and wherein the standard deviation includes a pre-test standard deviation of each of the experimental samples under the outcome variable in the independent-samples test method or a differential standard deviation of each of the experimental samples under the outcome variable in the paired-samples test method.

In an optional implementation, said determining, by using the independent-samples test method, the sample size corresponding to the experimental samples under the evaluation index includes: determining, based on the testing error and the pre-test standard deviation in the standard deviations, the sample size corresponding to the experimental samples under the evaluation index.

In an optional implementation, said determining, by using the paired-samples test method, the sample size corresponding to the experimental samples under the evaluation index includes: obtaining a correlation coefficient between the experimental group and the control group that consist of the experimental samples, the correlation coefficient indicating a correlation between outcome variables of respective experimental samples in the experimental group and outcome variables of respective experimental samples in the control group; and determining, based on the testing error, the differential standard deviation in the standard deviation and the correlation coefficient, the sample size corresponding to the experimental samples under the evaluation index.

In an optional implementation, said obtaining the correlation coefficient between the experimental group and the control group that consist of the experimental samples includes: performing pre-grouping processing on each of the experimental samples prior to obtaining the experimental scheme, and obtaining a simulation correlation coefficient between two simulated groups that are obtained subsequent to the pre-grouping processing as the correlation coefficient between the experimental group and the control group.

In an optional implementation, the method further includes, subsequent to said determining, based on the evaluation index, the sample size corresponding to the experimental samples in the experimental scheme: determining a sample loss rate, the sample loss rate representing a ratio of a number of reduced experimental samples to the sample size; and determining, based on the sample loss rate, a sample supplement quantity in the experimental scheme, and updating the sample size based on the sample supplement quantity.

In an optional implementation, the experimental variables further include a control variable, the control variable including a variable other than the causal variable and affecting the outcome variable; and wherein said obtaining the experimental samples under the sample size includes: obtaining a plurality of experimental samples, a variation caused by the plurality of experimental samples on the outcome variable under the control variable not exceeding a predetermined variation.

In an optional implementation, the experimental scheme includes an experimental scheme in the field of education; the experimental samples in the experimental scheme include students; and the control variable in the experimental variables includes at least one of a grade, a class, a score variation trend, and a current score level of the students in the experimental scheme.

In a second aspect, the embodiments of the present disclosure further provide a control test apparatus. The control test apparatus includes: an obtaining module configured to obtain an experimental scheme, and perform quantization processing on experimental variables in the experimental scheme to obtain a quantization index corresponding to each of the experimental variable, wherein the experimental variables include a causal variable and an outcome variable; a determining module configured to determine an evaluation index corresponding to the quantization index of the outcome variable, and determine, based on the evaluation index, a sample size corresponding to experimental samples in the experimental scheme, the evaluation index being used for evaluating a difference value between two outcome variables of an experimental group and a control group that are obtained under different causal variables in the experimental scheme; and an experimental module configured to obtain the experimental samples under the sample size, and divide the experimental samples into the experimental group and the control group based on a control grouping condition of the experimental scheme, for completing the experimental scheme by using the experimental group and the control group, wherein the quantization index of the causal variable corresponding to the experimental group is different from the quantization index of the causal variable corresponding to the control group.

In an optional implementation, the determining module is configured to, when determining, based on the evaluation index, the sample size corresponding to the experimental samples in the experimental scheme: determine, by using an independent-samples test method, the sample size corresponding to the experimental samples under the evaluation index; or determine, by using a paired-samples test method, the sample size corresponding to the experimental samples under the evaluation index.

In an optional implementation, the determining module is further configured to, prior to determining, based on the evaluation index, the sample size corresponding to the experimental samples in the experimental scheme: determine a testing error under the experimental scheme and a standard deviation of the experimental samples, wherein the testing error includes a probability of true-rejecting error and a probability of false-accepting error in the experimental scheme, and wherein the standard deviation includes a pre-test standard deviation of each of the experimental samples under the outcome variable in the independent-samples test method or a differential standard deviation of each of the experimental samples under the outcome variable in the paired-samples test method.

In an optional implementation, the determining module is configured to, when determining, by using the independent-samples test method, the sample size corresponding to the experimental samples under the evaluation index: determine, based on the testing error and the pre-test standard deviation in the standard deviations, the sample size corresponding to the experimental samples under the evaluation index.

In an optional implementation, the determining module is configured to, when determining, by using the paired-samples test method, the sample size corresponding to the experimental samples under the evaluation index: obtain a correlation coefficient between the experimental group and the control group that consist of the experimental samples, the correlation coefficient indicating a correlation between outcome variables of respective experimental samples in the experimental group and outcome variables of respective experimental samples in the control group; and determine, based on the testing error, the differential standard deviation in the standard deviation and the correlation coefficient, the sample size corresponding to the experimental samples under the evaluation index.

In an optional implementation, the correlation coefficient between the experimental group and the control group that consist of the experimental samples is obtained by: performing pre-grouping processing on each of the experimental samples prior to obtaining the experimental scheme, and obtaining a simulation correlation coefficient between two simulated groups that are obtained subsequent to the pre-grouping processing as the correlation coefficient between the experimental group and the control group.

In an optional implementation, the determining module is further configured to, subsequent to said determining, based on the evaluation index, the sample size corresponding to the experimental samples in the experimental scheme: determine a sample loss rate, the sample loss rate representing a ratio of a number of reduced experimental samples to the sample size; and determine, based on the sample loss rate, a sample supplement quantity in the experimental scheme, and updating the sample size based on the sample supplement quantity.

In an optional implementation, the experimental variables further include a control variable, the control variable including a variable other than the causal variable and affecting the outcome variable; and the determining module is further configured to obtain the experimental samples under the sample size by: obtaining a plurality of experimental samples, a variation caused by the plurality of experimental samples on the outcome variable under the control variable not exceeding a predetermined variation.

In an optional implementation, the experimental scheme includes an experimental scheme in the field of education; the experimental samples in the experimental scheme include students; and the control variable in the experimental variables includes at least one of a grade, a class, a score variation trend, and a current score level of the students in the experimental scheme.

In a third aspect, the embodiments of the present disclosure further provide a computer device. The computer device includes a memory and a processor. The memory has a machine-readable instruction stored thereon, and the machine-readable instruction is executable by the processor. The processor is configured to execute the machine-readable instruction stored in the memory to implement steps of the above method according to the first aspect or the steps of any one of possible implementations in the first aspect.

In a fourth aspect, the embodiments of the present disclosure further provide a computer-readable storage medium. The computer-readable storage medium has a computer program stored thereon. The computer program, when executed by a computer device, implements the steps of the above method according to the first aspect or the steps of any one of possible implementations in the first aspect.

In the control test method provided by the embodiment of the present disclosure, when the experimental scheme is determined, the quantization processing is performed on the experimental variables, enabling a description dimension of the experimental variables to be switched to a mathematical dimension thereof through the quantization index, such that a description dimension of the experimental variables is converted to a mathematical dimension through a quantization index. Then, a sample size, with which an expected experimental outcome can obtained in the experimental scheme, can be estimated by using an evaluation index corresponding to the quantization index of an outcome variable and considering the expected experimental outcome when the experimental scheme is actually implemented. In this way, an appropriate number of experimental samples for control testing can be obtained based on an estimated sample size. Therefore, in the method provided by the embodiments of the present disclosure, instead of selecting a large number of samples for testing, the required number of samples may be quantitatively determined based on the expected requirements for experimental outcomes, thereby reducing the waste of the experimental samples.

In order to clearly explain the above-mentioned objects, features, and advantages of the present disclosure, preferred embodiments are described below with reference to the accompanying drawings.

### BRIEF DESCRIPTION OF THE DRAWINGS

In order to clearly explain technical solutions of embodiments of the present disclosure, accompanying drawings used in the embodiments will be briefly described below, and the drawings herein are incorporated in and constitute a part of the specification. These drawings illustrate the embodiments according to the present disclosure and serve to explain the technical solutions of the present disclosure together with the specification. It should be understood that the following drawings illustrate only some embodiments of the present disclosure and thus they should not be construed as limiting the scope of the present disclosure. Based on these drawings, other drawings can be obtained by those of ordinary skill in the art without creative effort.

FIG. 1 is a flowchart of a control test method according to an embodiment of the present disclosure;

FIG. 2 is a specific flowchart of a control test method in a practical application according to an embodiment of the present disclosure;

FIG. 3 is a specific flowchart of an experimental condition assessment process according to an embodiment of the present disclosure;

FIG. 4 is a schematic diagram of a control test apparatus according to an embodiment of the present disclosure; and

FIG. 5 is a schematic diagram of a computer device according to an embodiment of the present disclosure.

### DETAILED DESCRIPTION

In order to clarify the objects, technical solutions, and advantages of the present disclosure, technical solutions according to embodiments of the present disclosure will be clearly and thoroughly described below in combination with accompanying drawings of the embodiments of the present disclosure. The embodiments described below are only a part of the embodiments of the present disclosure, rather than all of the embodiments. Generally, assemblies according to the embodiments of the present disclosure described and illustrated herein may be arranged and designed in different configurations. Accordingly, the following detailed description of the embodiments of the present disclosure is not intended to limit the protection scope of the present disclosure, but merely explains selected embodiments of the present disclosure. Based on the embodiments of the present disclosure, other embodiments obtained by those skilled in the art without paying creative efforts shall fall within the scope of the present disclosure.

According to research, in order to investigate the influence of respective variables on an experimental outcome in an experimental scheme, a control test method is usually used for carrying out experiments, and a large number of samples are used for testing. However, since there are many variables having an influence on the experimental outcome in the experimental scheme, the adopted samples should have changes for a specific variable in the control experiment and a controllable difference in other variables, in order to ensure accuracy of the experimental outcome of a control experiment. Such a limitation on the samples may result in that in the limited number of samples that can be used for testing. Therefore, it will easily cause a waste of the experimental samples by using a large number of samples for testing.

Based on the above research, the present disclosure provides a control test method. When the experimental scheme is determined, quantization processing is performed on the experimental variables, such that a description dimension of the experimental variables is converted to a mathematical dimension through a quantization index. Then, a sample size, with which an expected experimental outcome can obtained in the experimental scheme, can be estimated by using an evaluation index corresponding to the quantization index of an outcome variable and considering the expected experimental outcome when the experimental scheme is actually implemented. In this way, an appropriate number of experimental samples for control testing can be obtained based on an estimated sample size. Therefore, in the method provided by the embodiments of the present disclosure, instead of selecting a large number of samples for testing, the required number of samples may be quantitatively determined based on the expected requirements for experimental outcomes, thereby reducing the waste of the experimental samples.

The defects existing in the above schemes are the results obtained by the inventor through practice and careful research. Therefore, a discovery process of the above-mentioned problems and the solutions according to the present disclosure for the above-mentioned problems described below should be the contributions made by the inventor to the present disclosure in a process of the present disclosure.

It should be noted that similar numerals and letters indicate similar items in the following accompanying drawings. Therefore, once an item is defined in one of the accompanying drawings, it is unnecessary to define and explain the item in subsequent drawings.

In order to facilitate understanding the embodiments, the control test method disclosed in the embodiments of the present disclosure is described in detail. The control test method according to the embodiments of the present disclosure is generally executed by a computer device having a predetermined computing capability. For example, the computer device includes a terminal device, a server, or other processing devices. The terminal device may be a user equipment (UE), a mobile device, a user terminal, a terminal, a cellular phone, a cordless telephone, a personal digital assistant (PDA), a handheld device, a computing device, a vehicle-mounted device, a wearable device, and the like. In some possible implementations, the control test method may be implemented by invoking a computer-readable instruction stored in a memory through a processor.

The control test method according to the embodiments of the present disclosure is described below. The control test method according to the embodiments of the present disclosure may be applied in the fields such as Internet, and education. For example, on the Internet, when a video is delivered, it is tested whether a purchase link has an influence on user's purchasing of a product may be tested by selecting setting the purchase link corresponding to the product in a video containing a specific product or not. In the field of education, in a test for improving students' learning ability, Internet whether students with different learning manners have the improved learning ability by allowing the students to select a group learning manner or an independent learning manner. That is, in different fields, experimental variables are different with the different specific experimental problems. For example, the experimental variables in the field of the Internet are to set the purchase link corresponding to the product or not; and the experimental variables in the field of education are to adopt the group learning manner or the independent learning manner. Correspondingly, the experimental outcomes under the different experimental problems are also different. For example, in the above examples, the outcome of video delivery in the field of the Internet is that the user purchases the product or not, and the outcome in the field of education is that the students have the improved learning ability or not. In the following embodiments, a specific experimental process in the experimental scheme shall be described, which is not described in detail herein.

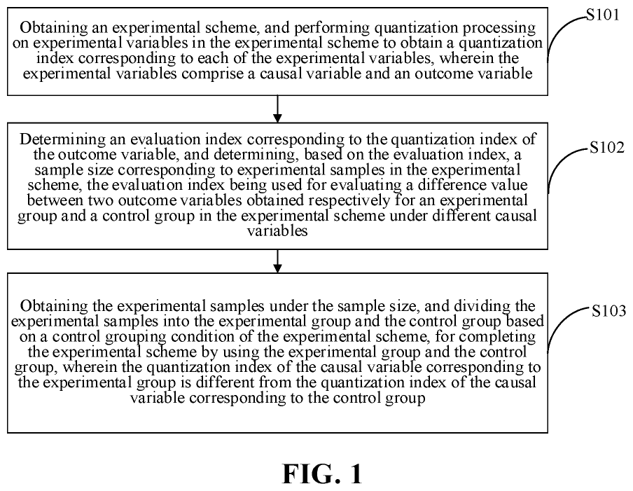

FIG. 1 is a flowchart of a control test method according to an embodiment of the present disclosure. The method includes the steps S101 to S103.

At step S101, an experimental scheme is obtained, and quantization processing is performed on experimental variables in the experimental scheme to obtain a quantization index corresponding to each of the experimental variables. The experimental variables include a causal variable and an outcome variable.

At step S102, an evaluation index corresponding to the quantization index of the outcome variable is determined, and a sample size corresponding to experimental samples in the experimental scheme is determined based on the evaluation index. The evaluation index is used for evaluating a difference value between two outcome variables obtained respectively for an experimental group and a control group in the experimental scheme under different causal variables.

At step S103, the experimental samples under the sample size are obtained, and the experimental samples are divided into the experimental group and the control group based on a control grouping condition of the experimental scheme, for completing the experimental scheme by using the experimental group and the control group. The quantization index of the causal variable corresponding to the experimental group is different from the quantization index of the causal variable corresponding to the control group.

As an example, the above steps S101 to S103 are described in detail below with a control experiment in the field of education.

For the above step S101, the experimental scheme is first described. The experimental scheme in the embodiments of the present disclosure is specifically used for completing the control experiment, and the control experiment aims to obtain a general conclusion about the influence of a single variable on the experimental outcome under the experimental problem. Therefore, the experimental problem is first determined before the experimental scheme is determined, and the experimental scheme may be definitely determined based on the specific experimental problem.

For example, the experimental problem may specifically include “influence of Feynman technique on students' metacognitive level”, “increasing the influence of a course reward on a degree of course participation”, and the like. The experimental scheme under the experimental problem is specifically selected based on the experimental problem. For example, regarding the above-mentioned experimental problem of “influence of the Feynman technique on the students' metacognitive level”, a specific experimental scheme may be designed to include: setting two groups of students, in one of which the students learn through the Feynman technique, and in the other one of which the student learn using a conventional learning method; and determining fluctuation influence of these two different learning methods on the students' metacognitive level through the control experiment method.

After the experimental scheme of the control experiment is proposed, a change of the outcome variable is specifically affected by changing the causal variable in the control experiment. Thus, the causal variable and the outcome variable in the experiment scheme may be definitely defined, to analyze the experiment outcomes by changing the variables during the experiment. The causal variable and the outcome variable all belong to the experimental variables in the experimental scheme. For example, the “conventional learning method” and the “Feynman technique” described above are used as a variable to be changed in the control experiment and affecting the students' learning metacognitive level. Therefore, in the experimental scheme, the experimental variable is a learning method, and the outcome variable is the students' metacognitive level.

After the experimental variable in the experimental scheme is determined, the general conclusion is obtained based on the influence on the outcome variable caused by the change of the causal variable in the specific experiment. Therefore, the experimental variables should be controllable and measurable. For example, the outcome variable of “the students' metacognitive level” can hardly be accurately evaluated or indicated with an index, such that the change of the outcome variable cannot be evaluated and it is difficult to draw the experimental conclusion under the experimental scheme. Therefore, the experimental variables in the experimental scheme are required to subjected to the quantization processing to obtain a quantization index corresponding to each experimental variable.

For example, with regard to the above outcome variable about “the students' metacognitive level”, students' score, which is an index indirectly expressed by a numerical value, may be used as a corresponding quantization index. Generally, the causal variable is controllable or optional. For example, the learning methods of the above-mentioned causal variable may be or may not be selected to be applied. The quantization processing is actually performed on the causal variable, i.e., whether a specific operation is selected.

In other examples, both the causal variable and the outcome variable in the experimental variables are quantified. For example, regarding an experimental scheme specifically for investigating an experimental problem about the influence of the course reward on the degree of course participation, the causal variable is to increase the course reward, and the outcome variable is students' attention to the course. For the causal variable, the actual course rewards may have different degrees, which are not limited to two cases of applying or not applying the above-mentioned learning methods in the above examples. Therefore, the quantization processing may be performed on both the causal variable and the outcome variable. For example, a predetermined quantization index of the causal variable is determined as course reward points, and a quantization index of the outcome variable is determined as learning duration.

In addition, after the quantization index corresponding to each experimental variable is determined, it may be re-checked for the experimental scheme whether the quantization index of the outcome variable can well indicate the influence caused by the change of the causal variable, whether such an indication property can expect that the outcome variable can have a large difference under different causal variables, and whether the outcome variable can have such a difference by using a predetermined number of samples.

For example, if a quantization index, obtained after the quantization processing, for the above-mentioned outcome variable of “the students' metacognitive level” is a capability assessment level such as level A and level B, such a quantization index cannot well indicate the difference, since the students' capability is unlikely to have a significant level promotion. If a significant level promotion is wished to be presented, a large number of students is required to ensure that the large number of students include the students having obvious level promotion, thereby enabling es the outcome variable to have a visible difference. In this case, the capability assessment level is an inappropriate quantization index, and other quantization indexes may be selected to replace the capability assessment level for evaluation and screening.

For the above step S102, after the quantization index corresponding to each experimental variable is determined, the sample size corresponding to the experimental samples in the experimental scheme may be estimated in advance based on the evaluation index corresponding to the quantization index of the outcome variable in the experimental variable.

The evaluation index is used for evaluating a difference value between two outcome variables obtained respectively for an experimental group and a control group in the experimental scheme under different causal variables. Since the experimental group and the control group may each include a plurality of experimental samples, the difference value between the outcome variables herein indicates a difference value between an average value of the outcome variables presented by the plurality of experimental samples in the experimental group and an average value of the outcome variables presented by the plurality of experimental samples in the control group. For example, the above-described quantization index of the outcome variable is determined as the learning duration, and the evaluation index is a difference value between average learning durations, such as 1 day, 1.5 days, etc.

For example, in the embodiments of the present disclosure, the evaluation index is expressed as X̅₁̅−X̅₂̅, to indicate an increase in the average value of the outcome variables of the experimental group relative to the control group. Since the experimental group and the control group may each include the plurality of experimental samples, X̅₁̅ represents an average value of the outcome variables presented by the plurality of experimental samples in the experimental group on, and X̅₂̅ represent an average value of the outcome variables presented by the plurality of experimental samples in the control group.

After the evaluation index corresponding to the quantization index of the outcome variable is determined, the sample size corresponding to the experimental samples in the experimental scheme can be determined based on the evaluation index. In a specific implementation, the sample size corresponding to the experimental samples in the experimental scheme can be determined based on the evaluation index in the following manner that the sample size corresponding to the experimental samples under the evaluation index is determined by using an independent-samples test method; or the sample size corresponding to the experimental samples under the evaluation index is determined by using a paired-samples test method. Both manners can obtain an accurate sample size and may be selected based on actual situations during actual use.

In order to determine the sample size by using the two manners, a testing error under the experimental scheme and a standard deviation of the experimental samples may be specifically obtained. The testing error includes a probability of true-rejecting error and a probability of false-accepting error in the experimental scheme. The standard deviations include a pre-test standard deviation of each of the experimental samples under the outcome variable in the independent-samples test method or a differential standard deviation of each of the experimental samples under the outcome variable in the paired-samples test method.

The testing error is first described below. The control experiment aims to verify whether the outcome variable of the control group and the experimental group can be changed by the change of the causal variable. In the above-mentioned experiment, the control experiment aims to verify whether the students' learning duration is prolonged by increasing the course reward. Further, in this experimental scheme, it is expected to be obtained such an experimental conclusion that the students' learning duration can be prolonged by increasing the course rewards. However, due to experimental falsifiability and unprovability, the above experimental conclusion is proved by falsifying “students' learning duration corresponding to the experimental group and the control group have no difference”. The “students' learning duration corresponding to the experimental group and the control group have no difference” is referred to as a “null hypothesis”, while the “students' learning duration corresponding to the experimental group and the control group have a difference” is referred to as an “alternative hypothesis”. The above experimental scheme is required to prove an influencing effect of the change of the causal variable on the outcome variable by means of statistic hypothesis testing.

On this basis, due to errors existing in the statistic hypothesis testing, the errors in the statistic hypothesis testing are also the above-mentioned testing errors, which may specifically include true-rejecting error and false-accepting error. The true-rejecting error may be referred to as the Type I Error, which rejects the null hypothesis when the above-mentioned null hypothesis is true. This error is an error mainly avoided in statistic hypothesis testing and has a probability specifically represented by α. A specific probability value of the Type I Error may be determined based on the actual situation, for example, 10% or 5%. In addition, α is also referred to as a significance level in the statistic hypothesis testing.

The false-accepting error may also be referred to as the Type II Error, which accepts a null hypothesis when the alternative hypothesis is false. This error is an error having relatively small impact on statistic hypothesis testing and has a probability specifically represented by β. Similar to the probability of the above Type I Error, the probability of the Type II Error may also be determined based on the actual situation, which may specifically be 20% or 10%. In addition, 1−β is also referred to as a statistical power in the statistic hypothesis testing.

For the standard deviation of the experimental samples, specific data used in different sample test methods are different.

A pre-test standard deviation is first described. The pre-test standard deviation represents a standard deviation of each of the experimental samples under the outcome variable in the independent-samples test method before the experimental scheme is performed. A “pre-test” refers to observation of the outcome variable before the control experiment, which may specifically focus on the outcome variable and other indexes such as students' degree of participation. In a pre-test process, reliable observation of the outcome variable may be obtained. For example, under an experiment exploring the influence of the course reward on course attention listed in the above examples, recording of students' learning duration in a period of time may be accumulated in the pre-test process. That is, the pre-test refers to a test for the experimental scheme within a period of time before a formal control test, in order to obtain basic experimental observation data in the test within this period of time.

Then, a differential standard deviation is described below. The differential standard deviation specifically represents a standard deviation corresponding to a difference value between the outcome variables of the control group and the experimental group. When the difference value between the outcome variables is determined, outcome data corresponding to the experimental samples may also be obtained within a period of time by using a pre-test method, which is not described in detail herein.

In order to distinguish different standard deviations of the above two sample test methods, in the embodiments of the present disclosure, the pre-test standard deviation is denoted asSD, and the differential standard deviation is denoted as SD_{D}.

After the testing error in the experimental scheme and the standard deviation of the experimental samples are determined, the sample size corresponding to the experimental samples under the evaluation index may be determined by using the independent-samples test method or the paired-samples test method. The method for determining the sample size by using the independent-samples test method is described in detail below. The sample size corresponding to the experimental samples may be determined by using the independent-samples test method based on the testing error and the pre-test standard deviation in the standard deviation.

The independent-samples test method is specifically a hypothesis test method based on t distribution, and it is used for randomly distributing the experimental samples to the experimental group and the control group, to perform statistical analysis on whether a difference in the outcome variables exists between the experimental group and the control group based on the t distribution. In order to obtain an accurate statistical outcome, a large number of samples is required to be adopted for testing. In the case of large sample size, for example, the sample size over 30, normal distribution of small samples under the t distribution may not be satisfied, such that a cumulative distribution function of the t distribution may be approximately a cumulative distribution function of z distribution (normal distribution). In this way, the sample size n required by one control experimental group in the independent-samples test method may be determined using the following equation (1-1):

$$n = \frac{( {s}_{{X}_{1}}^{2} + {s}_{{X}_{2}}^{2} ) {( {z}_{1 - α / 2} + {z}_{1 - β} )}^{2}}{{( \overline{{X}_{1}} - \overline{{X}_{2}} )}^{2}} , \qquad ( 1 - 1 )$$

where z_{1-α/2} represents a z value corresponding to the above-mentioned Type I Error, in which α/2 may be directly selected to be 0.05 or 0.1 based on the actual condition, and the z value may be found by searching in a standard normal distribution −z-value table under the z distribution; z_{1-β} represents a z value corresponding to the statistical power of the above description, which may be obtained by searching in the standard normal distribution −z-value table. In addition, the sample size specifically required in the present disclosure is a sample size N in the entire experimental scheme, and the sample sizes n in the experimental group and the control group are the same. Therefore, the sample size of the samples in the experimental scheme may be determined to be N=2n.

In the present disclosure, in order to better simplify the formula to reduce an operation difficulty and improve operation efficiency, a d index may be introduced to calculate the sample size n required by one control experimental group, thereby characterizing the experiment effect:

$$d = \frac{\overline{{X}_{1}} - \overline{{X}_{2}}}{SD} , \qquad ( 1 - 2 )$$

where the d index is also a ratio of the evaluation index to the pre-test standard deviation according to the above description.

On this basis, the following equation (1-3) can be obtained by introducing the d index:

$${SD}^{2} = \frac{( {n}_{1} - 1 ) {s}_{{X}_{1}}^{2} + ( {n}_{2} - 1 ) {s}_{{X}_{2}}^{2}}{{n}_{1} + {n}_{2} - 2} = {s}_{{X}_{1}}^{2} = {s}_{{X}_{2}}^{2} . \qquad ( 1 - 3 )$$

The sample size n required by one control experimental group in the above equation (1-1) may be derived and simplified as the following equation (1-4):

$$n = \frac{( {s}_{{X}_{1}}^{2} + {s}_{{X}_{2}}^{2} ) {( {z}_{1 - α / 2} + {z}_{1 - β} )}^{2}}{{( \overline{{X}_{1}} - \overline{{X}_{2}} )}^{2}} = \frac{2 {{SD}^{2} ( {z}_{1 - α / 2} + {z}_{1 - β} )}^{2}}{{( \overline{{X}_{1}} - \overline{{X}_{2}} )}^{2}} = \frac{2 {( {z}_{1 - α / 2} + {z}_{1 - β} )}^{2}}{{d}^{2}} . \qquad ( 1 - 4 )$$

For example, by assuming that the pre-test standard deviation SD obtained through the pre-test is 15 and taking α/2=0.1 and β=0.2, the followings may be found by searching in the standard normal distribution −z-value table:

$${z}_{1 - α / 2} = {z}_{0.9} = 1.645 \\ {z}_{1 - β} = {z}_{0.8} = 0.84 .$$

The sample size n required by the control experimental group may be simplified as the following equation (1-5):

$$n = \frac{2 {( {z}_{1 - α / 2} + {z}_{1 - β} )}^{2}}{{d}^{2}} = \frac{12.35045}{{d}^{2}} . \qquad ( 1 - 5 )$$

Assuming that the d index can be 0.2 based on the obtained evaluation index and the pre-test standard deviation, it may be calculated that the sample size required by one control experimental group is about 308.8. Since the samples characterized by the sample size are students, one control experimental group needs about 309 people to achieve the effect of the evaluation index after the experiment is completed. Correspondingly, in this manner, the sample size N is a sum of the sample size of the experimental group and the sample size of the control group, i.e., 618 people.

Then, the determination of the sample size corresponding to the experimental samples under the evaluation index by using the paired-samples test method is described below. In this method, in addition to the above-mentioned testing error and the differential standard deviation in the standard deviation, a correlation coefficient between the experimental group and the control group that consist of the experimental samples is also obtained. The correlation coefficient indicates a correlation between the outcome variables of respective experimental samples in the experimental group and the outcome variables of respective experimental samples in the control group. In a possible case, the correlation coefficient may specifically be a Pearson correlation coefficient (PCC).

In a specific implementation, the correlation coefficient between the experimental group and the control group that consist of the experimental samples can obtained by: performing pre-grouping processing on each of the experimental samples prior to obtaining the experimental scheme, and obtaining a simulation correlation coefficient between two simulated groups that are obtained subsequent to the pre-grouping processing as the correlation coefficient between the experimental group and the control group.

Since the correlation between the experimental group and the control group cannot be obtained through statistical calculation in a practical application, experimental simulation needs to be carried out, and a simulation correlation coefficient is determined through an outcome variable obtained after the experimental simulation, to serve as the correlation coefficient between the experimental group and the control group. During pre-grouping, the pre-grouping may be performed based on a grouping manner similar to that of the experimental scheme. A correlation coefficient between every two corresponding samples in the two simulated groups affects the correlation coefficient between the experimental group and the control group. The correlation coefficient is represented as corr in the embodiments of the present disclosure.

After the correlation coefficient between the experimental group and the control group is obtained, the sample size corresponding to the experimental samples under the evaluation index may be determined based on the testing error, the differential standard deviation in the above-mentioned standard deviations, and the correlation coefficient described herein.

In the paired-samples test method, the d index representing the effect size, which is different from the d index representing an effect size in the independent-samples test method, is expressed as d_{paired} and satisfies the following equation (2-1):

$${d}_{paired} = \frac{\overline{{X}_{D}}}{{SD}_{D}} , \qquad ( 2 - 1 )$$

where X̅_̅{̅D̅}̅ represents an average value corresponding to the outcome data corresponding to the experimental samples obtained by the pre-test within a period of time.

On this basis, when the sample size n of one control experimental group is calculated, n satisfies the following equation (2-2):

$${n}_{paired} = \frac{( {s}_{{X}_{1}}^{2} + {s}_{{X}_{2}}^{2} - {s}_{{X}_{1}} {s}_{{X}_{2}} corr ( {X}_{1} , {X}_{2} ) ) {( {z}_{α / 2} + {z}_{1 - β} )}^{2}}{{( \overline{{X}_{1}} - \overline{{X}_{2}} )}^{2}} . \qquad ( 2 - 2 )$$

With the manner similar to that in the independent-samples test method, the sample size n in one control experimental group can be obtained through calculation by substituting the specific value. Similarly, the sample size corresponding to the experimental samples in the experimental scheme satisfies N=2n.

When the sample size corresponding to the experimental samples is obtained using the above-mentioned two different sample test methods, it is merely considered that the number of experimental samples should be obtained in an ideal situation. However, in a specific experiment, due to the influence of the experimental samples themselves and the influence of a time process, the experimental samples may decrease. For example, the students may not complete the control experiment due to factors such as transferring to another school, changing a class, and active quit, and the students quitting before the end of the experiment may not provide effective outcome data, resulting in that the outcome variable of the control experiment cannot be effectively observed.

Therefore, after the sample size corresponding to the experimental samples is determined in the above-mentioned manners, a sample loss rate may be determined. The sample loss rate represents a ratio of a number of reduced experimental samples to the sample size. Based on the sample loss rate, a sample supplement quantity in the experimental scheme is determined, and the sample size is updated based on the sample supplement quantity.

The sample loss rate described herein may specifically represent various factors affecting the above-mentioned reduction of experimental samples. The influence of these factors on the experimental samples is increased with an increase of the sample loss rate. For example, during performing the control experiment, the sample loss rate may generally be controlled within 20%. In order to ensure completing of the experiment with the experimental samples as complete and effective as possible, in the embodiments of the present disclosure, the sample loss rate is specifically selected to be 25% to ensure a sufficient sample number of the experimental samples. The sample supplement quantity in the experimental scheme may be determined based on the sample loss rate. For example, based on the above-mentioned 618 people, the number of people should be increased to about 824=618/(1−25%), which is obtained by calculating based on the sample loss rate of 25%. In the control experiment, the number of people should be double increased to about 1099 in the experimental group and control group.

In this way, the sample size corresponding to the experimental sample in the experimental scheme may be obtained through the above steps, and it can also be ensured to a certain extent that the experimental samples under such a sample size can complete the selected experimental scheme with a higher probability.

For the above step S103, after the sample size of the experimental samples is determined through the above steps, the experimental samples may be obtained based on the sample size and be divided into the experimental group and the control group based on a control grouping condition of the experimental scheme, in order to complete the experimental scheme by using the experimental group and the control group. The quantization index of the causal variable corresponding to the experimental group is different from the quantization index of the causal variable corresponding to the control group.

The experimental samples are obtained in the specific manner as described below. The experimental samples are specifically used for completing the control experiment, to verify the influence of the casual variable on the outcome variable. Therefore, other variables other than the casual variable should be controlled to remain a relatively similar state or a same state for the experimental samples. For example, when the casual variable is to increase the course rewards as described in the above examples, the course rewards among the students are changed as the casual variable, which may affect the learning duration in the outcome variable. However, the students' learning duration may also vary due to different teachers and different subjects. For example, due to humorous teaching of a teacher A, a corresponding observable learning duration of the students taught by the teacher A may be longer than that of the students taught by other teachers. In this regard, when different students taught by different teachers are selected as the experimental samples, the obtained outcome variable may not objectively indicate the influence only caused by the casual variable.

In order to solve the above problem, a control variable may also be determined when the experimental variable is determined. The control variable is a variable other than the causal variable and affecting the outcome variable. Further taking the above-mentioned education field as an example, when the experimental scheme includes an experimental scheme under intelligent learning, it can be determined that the experimental samples in the experimental scheme include students, and the control variable in the experimental scheme includes at least one of students' grade, class, score variation trend, and current score level in the experimental scheme.

In fact, the control variables may not be completely eliminated. Taking the students' score variation trend as an example, it is impossible to find two students having the completely same score variation trend. Therefore, when the plurality of experimental samples is obtained, it should be ensured that a variation of the outcome variable caused by the plurality of experimental samples under the control variable does not exceed a predetermined variation. Further taking the score variation trend as an example, the corresponding predetermined variation may include, for example, two students having stable academic performance at top ranking.

In addition, in the control experiment, the minimum experimental group having two students may serve as the control to perform the control experiment, and thus, a variation caused by the two students in the minimum experimental group under the control variable does not exceed the predetermined variation, thereby reducing a selection limitation on the overall experimental samples.

In this way, after the experimental samples under the sample size is obtained, the control experiment may be completed through the experimental samples to obtain the experimental conclusion of the experimental problem.

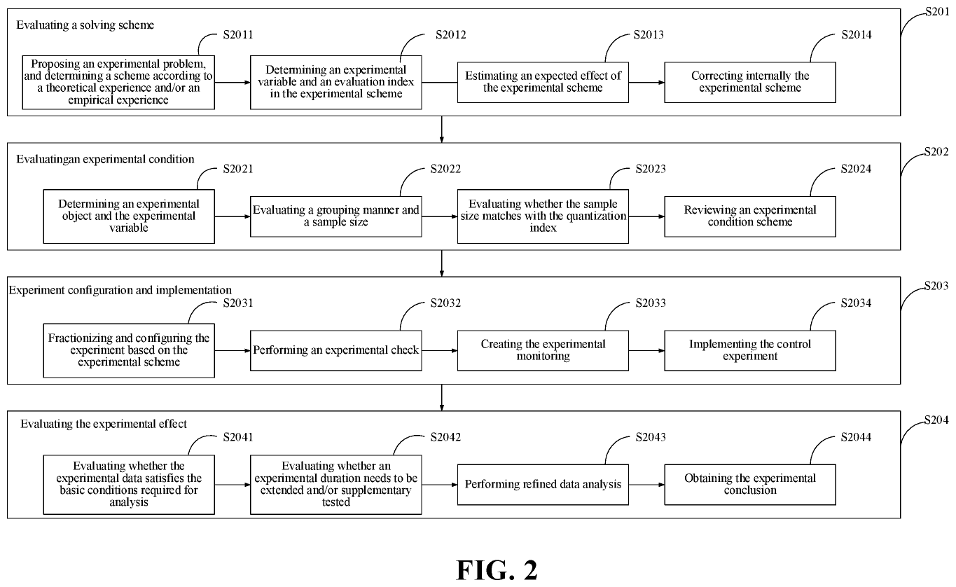

In another embodiment of the present disclosure, as illustrated in FIG. 2, a specific process of a control test method in an actual application is further provided, including steps S201 to S204.

At step S01, a solving scheme is evaluated.

This step is specifically used for proposing an experimental problem and formulating an experimental scheme for the proposed experimental problem; and determining an experimental variable and an evaluation index based on the formulated experimental problem. The step may be divided into the following four sub-steps, which specifically include: step S2011, proposing an experimental problem, and determining a scheme according to a theoretical experience and/or an empirical experience; step S2012, determining an experimental variable and an evaluation index in the experimental scheme; step S2013, estimating an expected effect of the experimental scheme; and step S2014, correcting internally the experimental scheme. For details, reference may be made to the above related description of steps S101 and S102, and details thereof will be omitted herein.

At step S202, an experimental condition is evaluated.

This step is specifically configured to evaluate conditions required for carrying out an experiment based on the experimental scheme. The step may be divided into the following four sub-steps, which specifically include: step S2021, determining an experimental object and the experimental variable; step S2022, evaluating a grouping manner and a sample size; step S2023, evaluating whether the sample size matches with the quantization index; and step S2024, reviewing an experimental condition scheme.

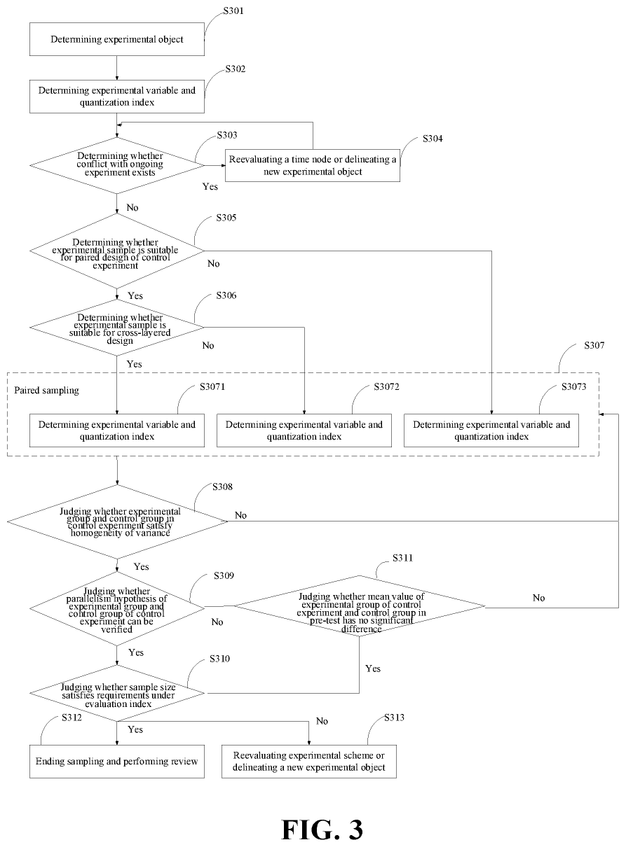

In this step, the embodiments of the present disclosure will be described in detail with reference to specific examples. FIG. 3 is a specific flowchart of an experimental condition assessment process according to an embodiment of the present disclosure, in which:

At step S301, an experimental object is determined.

At step S302, an experimental variable and a quantization index are determined.

The above steps S301 to S302 may specifically refer to the related descriptions in steps S101 to S102, which are not described in detail herein.

At step S303, it is determined whether a conflict with an ongoing experiment exists; and when the conflict exists, skipping to perform step S304, when no conflict exists, continuing to perform step S305.

At step S304, a time node is reevaluated or a new experimental object is delineated, to return to step S303.

Since the experimental object may be performing another control experiment, interference may be generated between the control experiments. For example, the students who are carrying out an experiment about “the influence of adding course rewards on the degree of course participation” are not suitable for simultaneously carrying out an experiment about “the influence of shortening a single class duration on the students' course satisfaction”. That is, when the experimental object is performing an experiment, and the outcome variable or the casual variable of the experiment is conflict with this control experiment, the experimental object is not suitable to participate in the control experiment at the same time.

At step S305, it is determined whether the experimental sample is suitable for paired design of the control experiment, when the experimental sample is suitable for the paired design of the control experiment, continuing to perform step S306, and when the experimental sample is unsuitable for the paired design of the control experiment, performing step S3073.

A pairing experiment means matching and grouping similar sample objects, enabling the control variable to have a smaller influence, thereby reducing the requirement on the sample size. The pairing design is suitable for control experiments with the pre-test. The pre-test herein can refer to the above description. That is, the pre-test step can reduce the influence of the control variable to a certain extent and reduce the sample size as much as possible, namely, reducing the difficulty of obtaining the experimental samples.

At step S306, it is determined whether the experimental sample is suitable for cross-layered design, when the experimental sample is suitable for the cross-layered design, continuing to perform step S3071; and when the experimental sample is unsuitable for the cross-layering design, performing step S3072.

The term “layering” refers to grade, class, etc., and it is a naturally-occurring nested structure. For example, the class is nested in a school, and the student is nested in the class. Each layer includes a large number of irrelevant variables, such as differences between control variables among different classes, such as teachers, management styles, average enrolled scores. When the experimental group and the control group in the control experiment are selected in a cross-layering manner, the difference between the layers may be balanced. However, some experiments such as “the influence of the Feynman technique on scores as described in the above examples may have influence among the students in the same class, and thus it's better to group the students in the same class into the same group (for example, in the experimental group or the control group), and it is necessary to perform strict quantification and matching on the control variables on the class layer.

At step S307, paired sampling is performed. This step specifically includes steps S3071 to S3073.

At step S3071: inter-layer paired sampling is performed.

The inter-layer paired sampling refers to a cross-layer sampling performed on the experimental group and the control group under the control experiment. For example, in an experiment about “the influence of adaptive recommendation of questions on students' scores”, 50 pairs of students are selected in total to be distributed in the experimental group and the control group. The 50 pairs of students may come from different classes of different schools, but two students in each pair are from the same class, to control interference caused by class factors.

At step S3072: intra-layer paired sampling is performed.

The intra-layer paired sampling, corresponding to the above inter-layer paired sampling, means that the students in the experimental group in the control experiment are required to come from different classes or schools. For example, it is assumed that 50 pairs of students from two classes are selected to participate in the experiment about “the influence of the Feynman technique on scores”, the students in the experimental group should come from one class, and the students in the control group come from the other one class. A matching rule may be based on similarity characterized by factors such as a pre-test outcome, which may refer to the above related description herein and is not described in detail herein.

At step S3073, random grouping sampling is performed on independent samples.

The random grouping sampling on the independent samples refers to a random sampling performed on the experimental group and the control group in a large sample. In some embodiments, when the pre-test is not performed on the experimental samples, the students' basic level is not known, and thus it may be impossible to avoid the influence of some of the control variables. In this case, it is necessary to provide a large number of random samples to ensure that the experimental group and the control group can be used to obtain an accurate experimental conclusion. Therefore, in the control experiment, the above-mentioned inter-layer paired sampling or intra-layer paired sampling should be selected.

At step S308, it is judged whether the experimental group and the control group in the control experiment satisfy homogeneity of variance, when the experimental group and the control group in the control experiment satisfy the homogeneity of variance, continuing to perform step S309, and when the experimental group and the control group in the control experiment fail to satisfy the homogeneity of variance, returning to perform step S307.

The homogeneity of variance, as a part of a statistic test, refers to whether the samples in the experimental group and the control group in the control experiment come from the same distribution, i.e., whether a deviation exists. When the homogeneity of variance is not satisfied, it indicates that the samples have the deviation and a re-sampling is required.

At step S309, it is judged whether a parallelism hypothesis of the experimental group and the control group in the control experiment can be verified, when the parallelism hypothesis of the experimental group and the control group in the control experiment can be verified, performing step S310, and when the parallelism hypothesis of the experimental group and the control group in the control experiment cannot be verified, performing step S311.

The parallelism hypothesis, as a part of a statistic hypothesis, is specifically used to indicate whether the students in two groups (i.e., the experimental group and the control group) have the same trend of horizontal growth or decrease when not participating in the experiment. The parallelism hypothesis requires more verification of historical data about the outcome variables, for example, the students' scores from multiple recent exams.

At step S310, it is judged whether the sample size satisfies requirements under the evaluation index, when the sample size satisfies the requirements under the evaluation index, performing step S312, and when the sample size satisfies no requirement under the evaluation index, performing step S313.

Reference may be made to the description in step S102, when the evaluation index is determined, the sample size may be estimated. When the selected samples cannot reach the sample size, the problem that the required experimental outcome may not be obtained after the experiment may occur.

At step S311, it is judged whether a mean value of the experimental group of the control experiment and the control group in the pre-test has no significant difference, when the mean value of the experimental group of the control experiment and the control group in the pre-test has no significant difference, performing step S310, and when the mean value of the experimental group of the control experiment and the control group in the pre-test has the significant difference, returning to performing step S307.

When the parallelism hypothesis cannot be verified, a statistic significance test may be carried out through pre-test, to determine whether students' levels in the experimental group and the control group of the adopted control experiment have similar development trends. In the control experiment, when the parallelism hypothesis cannot be verified, the experimental group and the control group need to be at least at the same baseline level, namely, a mean value of the experimental group is not significantly different from a mean value of the control group in the pre-test.

At step S312, the sampling is ended and review is performed.

Since the experimental samples obtained by sampling passes the evaluation of the above-mentioned multiple steps, it can be considered that these experimental samples meet the specific requirements in the experimental scheme. Thus, the sampling can be ended and it is reviewed whether the selected experimental samples are reliable.

At step S313, the experimental scheme is reevaluated or a new experimental object is delineated.

When the experimental samples fail to pass the evaluation of the above steps, it can be considered that the experimental scheme does not have good experimental sample. Thus, the experimental scheme can be reevaluated, or a new experimental object can be delineated again.

At step S203, the experiment is configured and performed.

In this step, the control experiment is mainly configured according to the experimental scheme and the experiment is monitored. This step may be divided into the following four sub-steps, which specifically include: step S2031, fractionizing and configuring the experiment according to the experimental scheme; step S2032, performing an experimental check, step S2033, creating the experimental monitoring; and step S2034, implementing the control experiment.

The experimental check may specifically include a simulation experiment and a related personnel check. The simulation experiment may simulate the control experiment by copying a real flow online, to perform an effect test on an effect index and an engineering index of the control experiment, and determine whether the influence of the experiment on a specific application is within a reasonable range. The step of checking the related personnel may specifically include: inviting an experiment-related person and/or a service-related person to check the control experiment. A specific check may direct to a service background, strategy rationality, configuration parameter correctness, an experimental risk, and the like of the control experiment. After a comprehensive evaluation is completed, it is judged whether the control experiment can be officially started.

At step S204, the experimental effect is evaluated.

This step is mainly used to scientifically evaluate a process and a conclusion of the control experiment. This step specifically includes the following four sub-steps: step S2041, evaluating whether the experimental data satisfies the basic conditions required for analysis; step S2042, evaluating whether an experimental duration needs to be extended and/or supplementary tested; step S2043, performing refined data analysis; and step S2044, obtaining the experimental conclusion.

The experimental data refers to experimental variables collected during the control experiment and observed quality assurance data. The evaluation of the experimental data includes: performing data analysis based on a variable relationship set in the experimental scheme to obtain a preliminary conclusion. In consideration of unexpected situations that may occur in the control experiment, for example, the sample size is underestimated in an experimental design stage, the sample loss rate in the experiment is higher than an estimated value, etc., a final outcome of the experiment may be affected, such that it shall be evaluated from respective aspects in the experiment whether the sample size shall be enlarged or the experiment period shall be prolonged. The obtained experimental outcome may include, for example, an experimental result that “the Feynman technique can improve the students' metacognitive level”, which is obtained under the experimental problem of “the influence of the Feynman technique on the students' metacognitive level”; an experimental result that “the increase of the course rewards can improve the degree of course participation”, which is obtained under the experimental problem of “the influence of increasing the course rewards on the degree of course participation”, and the like, thereby obtaining a corresponding improvement value and a statistical significance level.

It should be understood by those skilled in the art that, in the above-mentioned method of specific embodiments, the described order of the respective steps does not mean a strict execution order and does not constitute any limitation on the implementation process. The specific execution sequence of the respective steps should be determined by their functions and the possible internal logic.

Based on the same invention concept, the embodiments of the present disclosure further provide a control test apparatus corresponding to the control test method. The apparatus according to the embodiments of the present disclosure can solve the problems with the similar principle as the above-mentioned control test method according to the embodiments of the present disclosure, and thus the implementations of the apparatus may refer to the implementations of the method, which are not described in detail herein.

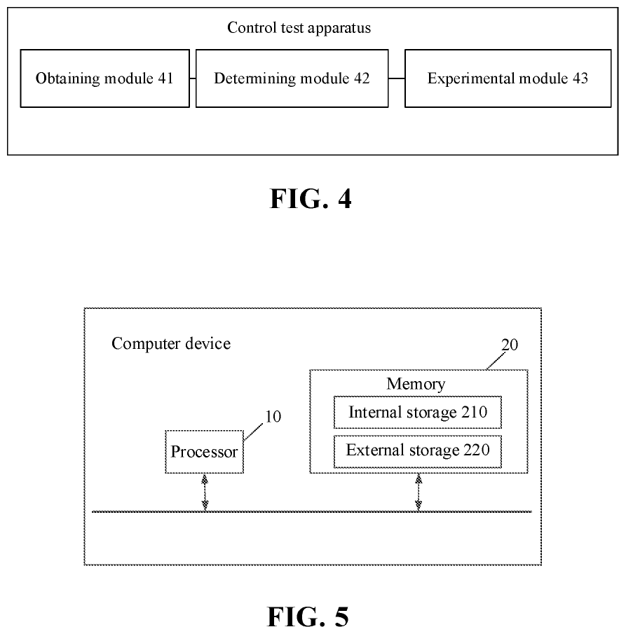

FIG. 4 is a schematic diagram of a control test apparatus according to an embodiment of the present disclosure. The apparatus includes an obtaining module 41, a determining module 42, and an experimental module 43.

The obtaining module 41 is configured to obtain an experimental scheme, and perform quantization processing on experimental variables in the experimental scheme to obtain a quantization index corresponding to each of the experimental variable. The experimental variables include a causal variable and an outcome variable.

The determining module 42 is configured to determine an evaluation index corresponding to the quantization index of the outcome variable, and determine, based on the evaluation index, a sample size corresponding to experimental samples in the experimental scheme. The evaluation index is used for evaluating a difference value between two outcome variables obtained respectively for an experimental group and a control group in the experimental scheme under different causal variables.

The experimental module 43 is configured to obtain the experimental samples under the sample size, and divide the experimental samples into the experimental group and the control group based on a control grouping condition of the experimental scheme, for completing the experimental scheme by using the experimental group and the control group. The quantization index of the causal variable corresponding to the experimental group is different from the quantization index of the causal variable corresponding to the control group.

In an optional implementation, the determining module 42 is further configured to, when determining, based on the evaluation index, the sample size corresponding to the experimental samples in the experimental scheme: determine, by using an independent-samples test method, the sample size corresponding to the experimental samples under the evaluation index; or determine, by using a paired-samples test method, the sample size corresponding to the experimental samples under the evaluation index.

In an optional implementation, the determining module 42 is further configured to, prior to determining, based on the evaluation index, the sample size corresponding to the experimental samples in the experimental scheme: determine a testing error under the experimental scheme and a standard deviation of the experimental samples. The testing error includes a probability of Type I Error and a probability of Type II Error in the experimental scheme, and the standard deviation includes a pre-test standard deviation of each of the experimental samples under the outcome variable in the independent-samples test method or a differential standard deviation of each of the experimental samples under the outcome variable in the paired-samples test method.

In an optional implementation, the determining module 42 is further configured to, when determining, by using the independent-samples test method, the sample size corresponding to the experimental samples under the evaluation index: determine, based on the testing error and the pre-test standard deviation in the standard deviation, the sample size corresponding to the experimental samples under the evaluation index.

In an optional implementation, the determining module 42 is further configured to, when determining, by using the paired-samples test method, the sample size corresponding to the experimental samples under the evaluation index: obtain a correlation coefficient between the experimental group and the control group that consist of the experimental samples, the correlation coefficient indicating a correlation between outcome variables of respective experimental samples in the experimental group and outcome variables of respective experimental samples in the control group; and determine, based on the testing error, the differential standard deviation in the standard deviation, and the correlation coefficient, the sample size corresponding to the experimental samples under the evaluation index.

In an optional implementation, said obtaining the correlation coefficient between the experimental group and the control group that consist of the experimental samples includes: performing pre-grouping processing on each of the experimental samples prior to obtaining the experimental scheme, and obtaining a simulation correlation coefficient between two simulated groups that are obtained subsequent to the pre-grouping processing as the correlation coefficient between the experimental group and the control group.

In an optional implementation, the determining module 42 is further configured to, subsequent to determining, based on the evaluation index, the sample size corresponding to the experimental samples in the experimental scheme: determine a sample loss rate, the sample loss rate representing a ratio of a number of reduced experimental samples to the sample size; and determine, based on the sample loss rate, a sample supplement quantity in the experimental scheme, and update the sample size based on the sample supplement quantity.

In an optional implementation, the experimental variables further include a control variable. The control variable includes a variable other than the causal variable and affecting the outcome variable. The determining module 42 is further configured to obtain the experimental samples under the sample size by: obtaining a plurality of experimental samples, a variation caused by the plurality of experimental samples on the outcome variable under the control variable not exceeding a predetermined variation.

In an optional implementation, the experimental scheme includes an experimental scheme in the field of education; the experimental samples in the experimental scheme include students; and the control variable in the experimental variables includes at least one of a grade, a class, a score variation trend, and a current score level of the students in the experimental scheme. A processing flow of the respective modules in the apparatus and an interaction process between the modules can refer to the related description in the above method embodiments, and they are not described in detail herein.

The embodiments of the present disclosure further provide a computer device. FIG. 5 is a schematic structural diagram of a computer device according to an embodiment of the present disclosure. The computer device includes a processor 10 and a memory 20. The memory 20 has a machine-readable instruction stored thereon and executable by the processor 10. The processor 10 is configured to execute the machine-readable instruction stored in the memory 20 to implement the following steps: obtaining an experimental scheme, and performing quantization processing on experimental variables in the experimental scheme to obtain a quantization index corresponding to each of the experimental variables, in which the experimental variables include a causal variable and an outcome variable; determining an evaluation index corresponding to the quantization index of the outcome variable, and determining, based on the evaluation index, a sample size corresponding to experimental samples in the experimental scheme, the evaluation index being used for evaluating a difference value between two outcome variables obtained respectively for an experimental group and a control group in the experimental scheme under different causal variables; and obtaining the experimental samples under the sample size, and dividing the experimental samples into the experimental group and the control group based on a control grouping condition of the experimental scheme, for completing the experimental scheme by using the experimental group and the control group, in which the quantization index of the causal variable corresponding to the experimental group is different from the quantization index of the causal variable corresponding to the control group.

The above-mentioned memory 20 includes an internal storage 210 and an external storage 220. The internal storage 210 herein is also referred to as a memory for temporarily storing operation data in the processor 10 and data exchangeable with an external storage 220, for example, a hard disk. The processor 10 can exchange data with the external storage 220 through the internal storage 210.

The specific execution process of the instructions may refer to the steps of the control test method described in the embodiments of the present disclosure, and details thereof will be omitted here.

The embodiments of the present disclosure further provide a computer-readable storage medium. The storage medium has a computer program stored thereon. The computer program, when executed by a processor, implements steps of the control test method according to any of the above method embodiments. The storage medium may be a volatile or non-volatile computer-readable storage medium.

The embodiments of the present disclosure further provide a computer program product. The computer program product carries a program code. The program code includes instructions configured to perform the steps of the control test method described in the above method embodiments. The specific description of the control test method may refer to the previous method embodiments, which is not described in detail herein.

The computer program product described above may be implemented by means of the hardware, software, or their combination. In an optional embodiment, the computer program product is specifically embodied as a computer storage medium. In another optional embodiment, the computer program product is specifically embodied as a software product, such as a software development kit (SDK), etc.

Those skilled in the art can clearly understand that, for the convenience and conciseness of the description, for the specific operation processes of the systems and apparatuses, described above, reference can be made to the corresponding processes in the foregoing method embodiments, and details thereof will be omitted here. In several embodiments provided by the present disclosure, it is to be understood that, the systems, apparatuses, and methods disclosed can be implemented in other ways. For example, the apparatus embodiments described above are merely exemplary. For example, the units are divided based on logic functions. In practical implementation, the units can be divided in other manners. For example, multiple units or components can be combined or integrated into another system, or some features can be omitted or not executed. In addition, mutual coupling, direct coupling, or communication connection described or discussed can be implemented as indirect coupling or communication connection via some communication interfaces, apparatuses or units, and may be electrical, mechanical or in other forms.

The modules illustrated as separate components may be or not be separated physically. The components illustrated as units may be or not be physical units, i.e., they may be located at one position, or distributed onto multiple network unit. It is possible to select some or all of the modules according to actual needs, for achieving the objective of embodiments of the present disclosure.

In addition, respective functional units in respective embodiments of the present disclosure can be integrated into one processing unit, or can exist as separate physical entities. It is also possible to integrate two or more units into one unit.

When the function is implemented in the form of a software functional unit and sold or used as a standalone product, it can be stored in a non-volatile computer-readable storage medium that is executable by a processor. In this regard, part of the technical solutions according to the present disclosure or the part thereof that contributes to the prior art can be embodied in the form of a software product. The computer software product may be stored in a storage medium and contain instructions, enabling a computer device, such as a personal computer, a server, or a network device to perform all or part of the steps of the method described in each of the embodiments of the present disclosure. The storage medium may include various mediums capable of storing program codes, such as a Universal Serial Bus flash drive, a mobile hard disk, a Read-Only Memory (ROM), a Random Access Memory (RAM), a magnetic disk, or an optical disc.

Finally, it should be noted that the above embodiments are merely specific implementations of the present disclosure for illustrating, rather than limiting, the technical solutions of the present disclosure. The protect scope of the present disclosure is not limited by these embodiments. Although the present disclosure has been described in detail with reference to the above embodiments, those skilled in the art should understand that, they can make modifications to the technical solutions described in the above embodiments or conceive variants thereof, or they can equivalently replace some of the technical features of the technical solutions described in the above embodiments, without departing from the technical scope of the present disclosure. These modifications, variants, or replacements do not cause the essence of corresponding technical solutions to deviate from the spirit and scope of the technical solutions of the embodiments of the present disclosure, and they shall fall within the scope of the present disclosure. Therefore, these modifications, variants, and replacements are to be encompassed by the protect scope of present disclosure as defined by the claims as attached.

1. A control test method, comprising:
obtaining an experimental scheme, and performing quantization processing on experimental variables in the experimental scheme to obtain a quantization index corresponding to each of the experimental variables, wherein the experimental variables comprise a causal variable and an outcome variable;
determining an evaluation index corresponding to the quantization index of the outcome variable, and determining, based on the evaluation index, a sample size corresponding to experimental samples in the experimental scheme, the evaluation index being used for evaluating a difference value between two outcome variables obtained respectively for an experimental group and a control group in the experimental scheme under different causal variables; and
obtaining the experimental samples under the sample size, and dividing the experimental samples into the experimental group and the control group based on a control grouping condition of the experimental scheme, for completing the experimental scheme by using the experimental group and the control group, wherein the quantization index of the causal variable corresponding to the experimental group is different from the quantization index of the causal variable corresponding to the control group.

2. The method according to claim 1, wherein said determining, based on the evaluation index, the sample size corresponding to the experimental samples in the experimental scheme comprises:
determining, by using an independent-samples test method, the sample size corresponding to the experimental samples under the evaluation index; or determining, by using a paired-samples test method, the sample size corresponding to the experimental samples under the evaluation index.

3. The method according to claim 2, further comprising, prior to said determining, based on the evaluation index, the sample size corresponding to the experimental samples in the experimental scheme:
determining a testing error under the experimental scheme and a standard deviation of the experimental samples, wherein the testing error comprises a probability of true-rejecting error and a probability of false-accepting error in the experimental scheme, and wherein the standard deviation comprises a pre-test standard deviation of each of the experimental samples under the outcome variable in the independent-samples test method or a differential standard deviation of each of the experimental samples under the outcome variable in the paired-samples test method.

4. The method according to claim 3, wherein said determining, by using the independent-samples test method, the sample size corresponding to the experimental samples under the evaluation index comprises:
determining, based on the testing error and the pre-test standard deviation in the standard deviations, the sample size corresponding to the experimental samples under the evaluation index.

5. The method according to claim 3, wherein said determining, by using the paired-samples test method, the sample size corresponding to the experimental samples under the evaluation index comprises:
obtaining a correlation coefficient between the experimental group and the control group that consist of the experimental samples, the correlation coefficient indicating a correlation between outcome variables of respective experimental samples in the experimental group and outcome variables of respective experimental samples in the control group; and
determining, based on the testing error, the differential standard deviation in the standard deviation and the correlation coefficient, the sample size corresponding to the experimental samples under the evaluation index.

6. The method according to claim 5, wherein said obtaining the correlation coefficient between the experimental group and the control group that consist of the experimental samples comprises:
performing pre-grouping processing on each of the experimental samples prior to obtaining the experimental scheme, and obtaining a simulation correlation coefficient between two simulated groups that are obtained subsequent to the pre-grouping processing as the correlation coefficient between the experimental group and the control group.

7. The method according to claim 2, further comprising, subsequent to said determining, based on the evaluation index, the sample size corresponding to the experimental samples in the experimental scheme:
determining a sample loss rate, the sample loss rate representing a ratio of a number of reduced experimental samples to the sample size; and
determining, based on the sample loss rate, a sample supplement quantity in the experimental scheme, and updating the sample size based on the sample supplement quantity.

8. The method according to claim 1, wherein the experimental variables further comprise a control variable, the control variable comprising a variable other than the causal variable and affecting the outcome variable; and wherein said obtaining the experimental samples under the sample size comprises:
obtaining a plurality of experimental samples, a variation caused by the plurality of experimental samples on the outcome variable under the control variable not exceeding a predetermined variation.

9. The method according to claim 8, wherein:
the experimental scheme comprises an experimental scheme in the field of education;
the experimental samples in the experimental scheme comprise students; and
the control variable in the experimental variables comprises at least one of a grade, a class, a score variation trend, and a current score level of the students in the experimental scheme.

10. A computer device, comprising:
a memory; and
a processor, wherein:
the memory has a machine-readable instruction stored thereon, the machine-readable instruction being executable by the processor; and
the processor is configured to execute the machine-readable instruction stored in the memory to implement a control test method, the control test method comprising:
obtaining an experimental scheme, and performing quantization processing on experimental variables in the experimental scheme to obtain a quantization index corresponding to each of the experimental variables, wherein the experimental variables comprise a causal variable and an outcome variable;
determining an evaluation index corresponding to the quantization index of the outcome variable, and determining, based on the evaluation index, a sample size corresponding to experimental samples in the experimental scheme, the evaluation index being used for evaluating a difference value between two outcome variables obtained respectively for an experimental group and a control group in the experimental scheme under different causal variables; and
obtaining the experimental samples under the sample size, and dividing the experimental samples into the experimental group and the control group based on a control grouping condition of the experimental scheme, for completing the experimental scheme by using the experimental group and the control group, wherein the quantization index of the causal variable corresponding to the experimental group is different from the quantization index of the causal variable corresponding to the control group.

11. The computer device according to claim 10, wherein said determining, based on the evaluation index, the sample size corresponding to the experimental samples in the experimental scheme comprises:
determining, by using an independent-samples test method, the sample size corresponding to the experimental samples under the evaluation index; or determining, by using a paired-samples test method, the sample size corresponding to the experimental samples under the evaluation index.

12. The computer device according to claim 11, wherein the control test method further comprises, prior to said determining, based on the evaluation index, the sample size corresponding to the experimental samples in the experimental scheme:
determining a testing error under the experimental scheme and a standard deviation of the experimental samples, wherein the testing error comprises a probability of true-rejecting error and a probability of false-accepting error in the experimental scheme, and wherein the standard deviation comprises a pre-test standard deviation of each of the experimental samples under the outcome variable in the independent-samples test method or a differential standard deviation of each of the experimental samples under the outcome variable in the paired-samples test method.

13. The computer device according to claim 12, wherein said determining, by using the independent-samples test method, the sample size corresponding to the experimental samples under the evaluation index comprises:
determining, based on the testing error and the pre-test standard deviation in the standard deviations, the sample size corresponding to the experimental samples under the evaluation index.

14. The computer device according to claim 12, wherein said determining, by using the paired-samples test method, the sample size corresponding to the experimental samples under the evaluation index comprises:
obtaining a correlation coefficient between the experimental group and the control group that consist of the experimental samples, the correlation coefficient indicating a correlation between outcome variables of respective experimental samples in the experimental group and outcome variables of respective experimental samples in the control group; and
determining, based on the testing error, the differential standard deviation in the standard deviation and the correlation coefficient, the sample size corresponding to the experimental samples under the evaluation index.

15. The computer device according to claim 14, wherein said obtaining the correlation coefficient between the experimental group and the control group that consist of the experimental samples comprises:
performing pre-grouping processing on each of the experimental samples prior to obtaining the experimental scheme, and obtaining a simulation correlation coefficient between two simulated groups that are obtained subsequent to the pre-grouping processing as the correlation coefficient between the experimental group and the control group.

16. The computer device according to claim 11, wherein the control test method further comprises, subsequent to said determining, based on the evaluation index, the sample size corresponding to the experimental samples in the experimental scheme:
determining a sample loss rate, the sample loss rate representing a ratio of a number of reduced experimental samples to the sample size; and
determining, based on the sample loss rate, a sample supplement quantity in the experimental scheme, and updating the sample size based on the sample supplement quantity.

17. The computer device according to claim 10, wherein the experimental variables further comprise a control variable, the control variable comprising a variable other than the causal variable and affecting the outcome variable; and wherein said obtaining the experimental samples under the sample size comprises:
obtaining a plurality of experimental samples, a variation caused by the plurality of experimental samples on the outcome variable under the control variable not exceeding a predetermined variation.

18. The computer device according to claim 17, wherein:
the experimental scheme comprises an experimental scheme in the field of education;
the experimental samples in the experimental scheme comprise students; and
the control variable in the experimental variables comprises at least one of a grade, a class, a score variation trend, and a current score level of the students in the experimental scheme.

19. A computer-readable storage medium, having a computer program stored thereon, wherein the computer program, when executed by a computer device, implements a control test method, the control test method comprising:
obtaining an experimental scheme, and performing quantization processing on experimental variables in the experimental scheme to obtain a quantization index corresponding to each of the experimental variables, wherein the experimental variables comprise a causal variable and an outcome variable;
determining an evaluation index corresponding to the quantization index of the outcome variable, and determining, based on the evaluation index, a sample size corresponding to experimental samples in the experimental scheme, the evaluation index being used for evaluating a difference value between two outcome variables obtained respectively for an experimental group and a control group in the experimental scheme under different causal variables; and
obtaining the experimental samples under the sample size, and dividing the experimental samples into the experimental group and the control group based on a control grouping condition of the experimental scheme, for completing the experimental scheme by using the experimental group and the control group, wherein the quantization index of the causal variable corresponding to the experimental group is different from the quantization index of the causal variable corresponding to the control group.
